(19) United States
(12) Patent Application Publication
(10) Pub. No.: US 2014/0108071 A1
(43) Pub. Date: Apr. 17, 2014

(54) ONTOLOGY OF DYNAMIC ENTITIES

(71) Applicants: INTERNATIONAL BUSINESS MACHINES CORPORATION, Armonk, NY (US); COLLIBRA, Brussels (BE)

(72) Inventors: David Boaz, Bahan (IL); Pieter De Leenheer, Brussels (BE); Richard B. Hull, Morris County, NJ (US); Lior Limonad, Nesher (IL); Mark H. Linehan, Westchester, NY (US)

(73) Assignees: COLLIBRA, Brussels (BE); INTERNATIONAL BUSINESS MACHINES CORPORATION, Armonk, NY (US)

(21) Appl. No.: 13/651,472

(22) Filed: Oct. 15, 2012

(51) Int. Cl. G06Q 10/06

(52) U.S. Cl. CPC G06Q 10/063
USPC 705/7.11

(57) ABSTRACT

A method, apparatus, data model and computer program product for providing entities having transient properties. The method may be performed by a computerized device and comprises: receiving an initial entity type specification, the initial specification comprising lifecycle of the entity type; receiving an indication of a transient property for the entity type; and receiving a possession formula for the transient property, wherein the possession formula is associated with a stage or condition in the lifecycle of at least one entity type.

### TECHNICAL FIELD

The present disclosure relates to data structures in general, and to systems supporting entities with transient properties, in particular.

### BACKGROUND

As computerized systems are becoming an essential part of any aspect of our lives, and especially manufacturing environments, there is an increased need for integration, collaboration and sharing data between heterogeneous systems. For example, Enterprise Application Integration (EAI) and Service Interoperability are aimed at the realization of cross-party operations through the establishment of software architecture and computer service links between originally independent units. The design of such technological ties typically relies on the construction of a semantic layer, serving as an underlying conceptualization layer to help design concrete data and service adapters for matching the different semantics between the systems. For integrating the business units that take part in the system, a product may be used which typically resides at the core of the semantic layer and defines a corresponding ‘business ontology’, typically expressed using concrete grammar, e.g., textual grammar such as Semantics of Business Vocabulary and Business Rules (SBVR), visual grammar such as UML, class diagrams, Entity-Relational (ER) diagrams, an XML-based system such as the Web Ontology Language (OWL), the Resource Description Framework (RDF), or the like, providing a detailed specification of key business entity types. Such business entity types represent mutually agreed upon conceptualizations of the mutual domain of integration. The more aligned the specification of the semantic layer with the individual domain conceptualizations of each partner, the easier it becomes to synchronize data and operation across the enterprise. Ensuring such alignment imposes two important requirements from the concrete grammar used to specify the business ontology: accuracy and lifecycle-congruency.

Accuracy may refer to descriptive validity, i.e., the capability of the grammar to accurately and comprehensively represent all the required business aspects, elements and processes and their properties, as generally accepted or perceived by the corresponding community of users. Achieving accurate representation has been traditionally the focus of domain specific ontologies, realized by the usage of conceptual modeling languages such as ER modeling as the specification language to specify entities, attributes, relationships and other governing rules such as cardinality constraints.

Lifecycle-congruency may refer to the usage of dynamic entities including requiring their validity along the lifecycle of the elements and processes, i.e., the capability of the grammar to coherently and unambiguously represent all business elements in different contexts and applications, synchronized with the timely perception of the elements' properties by the users. For example, it is possible that a manufactured product (e.g., a car) is considered as possessing a “Price” property only after having passed all quality assurance tests during its manufacturing. Before that point in its life cycle, the property price has no meaning regarding the car being produced.

In order to provide for lifecycle-congruency, in this disclosure we extend the specification of entity types with the apparatus being required for the description of transient properties, i.e., properties whose possession by an entity is subject to stages or conditions in its lifecycle.

### BRIEF SUMMARY OF THE INVENTION

One aspect of the disclosure relates to a computer-implemented method. performed by a computerized device, the method comprising: receiving an initial entity type specification, the initial specification comprising lifecycle of the entity type; receiving an indication of a transient property for the entity type; and receiving a possession formula for the transient property, wherein the possession formula is associated with a stage or condition in the lifecycle of at least one entity type.

Another aspect of the disclosure relates to an apparatus having a processing unit and a storage device, the apparatus comprising: an entity receiving component for receiving an initial specification of an entity type, the specification comprising lifecycle of the entity type; a transient property specification receiving component for receiving an indication specification of the entity type; and a possession formula receiving component for receiving a possession formula for the transient property, wherein the possession formula is associated with a stage or condition in the lifecycle of an entity type.

Yet another aspect of the disclosure relates to a data model retained on a non-transitory computer readable medium, the data model associated with an entity type, wherein entities of the entity type are manipulated in a computer program, wherein the data model comprising entity specification of the entity type, wherein the entity specification comprises lifecycle and at least one property of the entity type, wherein the at least one property comprises a transient property of the entity type; wherein the entity specification comprises a possession formula for the transient property, wherein the possession formula is associated with a stage or condition in the lifecycle of an entity type.

Yet another aspect of the disclosure relates to a computer program product stored on a non-transitory computer readable medium, the computer program product comprising: a first program instruction for receiving an initial entity specification associated with an entity type, the initial entity specification comprising lifecycle of the entity type; a second program instruction for receiving an indication of a transient property for the entity type; and a third program instruction for receiving a possession formula for the transient property, wherein the possession formula is associated with a stage or condition in a lifecycle of at least one entity, and wherein said first, second and third program instructions are stored on said non-transitory computer readable medium.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a flowchart of steps in a method for constructing an ontology having entities with transient properties, in accordance with some exemplary embodiments of the disclosed subject matter; and

FIG. 2 is a block diagram of components of an apparatus for constructing an ontology having entities with transient properties, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block or blocks of block diagrams.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is the lack of solutions and systems, including software solutions, which support lifecycle congruency of entities, meaning that the mere existence or possession of properties in an entity of a particular entity type may be subject to one or more conditions associated with the lifecycle of the entity.

In the context of the disclosure, an entity type or kind may refer to a set of entities having in common a set of properties. The set of common properties is part of the entity type specification. For example, the entity type “car” may be specified as all entities having wheels, engine, passenger-capacity, and color as part of their properties. In some embodiments, a valued attribute may be used in the specification of an entity type as a machine based representation for a property. For example, the entity type “colored object” may be specified with the attribute “color”. This implementation may be interpreted as if any possible value assignment to the attribute designates a valid property possession, such that for example an entity whose actual color is “yellow” would immediately be considered an instance of the “colored object” type.

A lifecycle specification is also part of an entity type specification. A lifecycle may mean any type of specification associated with the entity type, which may impose restrictions on an otherwise arbitrary evolution of entities, such as state transition rules, transition guards, or the like.

Currently, no existing apparatus supporting ontologies can account for this need in designing grammars that may adequately describe dynamic entity types, i.e., entity types with transient properties, wherein a further difficulty related to properties is that each property, in addition to being persistent or transient may also be mutable or immutable.

For example, in a car manufacturing and retailing environment, the car's price may be a transient property since a car can be sold only once it is manufactured, and the price may be a mutable property since it may change over time. However, having passenger-capacity may be a persistent and immutable property of a car, a color may be persistent and mutable, or the like.

Another technical problem dealt with by the disclosed subject matter is the difficulty of integrating data from different systems, due to the lack of explicit specification of the validity of data that is coming from the different sources in cases in which data from one system is to be integrated into or used with data from another system. In nowadays reality the recognition of which data is valid at what stages is implicit (e.g., in the code that forms it) rather than being explicit in the ontology (i.e., the specification of entity types).

One technical solution for the problem comprises an apparatus for implementing a business ontology, wherein the apparatus may be designed to receive descriptions of dynamic entities having transient properties. In order to support these abilities, the apparatus may provide “property possession algebra” for implementing transient properties and their behavior along the lifecycle of corresponding entities.

In accordance with the disclosure, each entity type in an ontology, such as a business ontology, may be specified to possess zero, one or more transient properties, and zero, one or more persistent properties, and execution units may be provided for manipulating the existence and values of the properties, including the transient properties.

In the context of the disclosure, the terms “possession” or “expression” may be used to indicate that a property is a quality or trait of an entity or an object, wherein a persistent property may be defined as a property whose possession is fixed across the lifecycle of the entity possessing it, while a transient property may be defined as a property whose possession may change across the lifecycle of the entity, such that the entity may possess the property at some times and may not possess it at other times.

It will be appreciated that the possession of a property, whether persistent or transient, may be perceived or viewed by an observer in a way that makes the perception itself transient. Thus, on the ontological level, the notion of transience is a fundamental characteristic or trait of the entities being expressed by the ontology regardless of any external view, while on the perceptional level in which the perception of property possession may be a function of various contextual and spatial dimensions such as: calendar time, participant's or role's perspective, geography and other. We acknowledge that the latter has been somewhat approached in prior art (e.g., expressed in the form of access controls and views) while the focus of this disclosure is the former.

The possession of a transient property may be a function of phases in the lifecycle of the entities being conceptualized by the ontology. Such evolutionary phases or stages may sometime be associated with absolute temporal expressions or conditions, but may also be associated with conditions not necessarily related to time. For example, a “person” may have a “guardian” property from his birth and until the person is eighteen years old, which indicates a specific point in time. However, a guardian may also be associated with the person at a later point in time which cannot be determined as a function of absolute or even relative time, for example if and when the person is declared as incompetent to take care of himself due to illness, mental state, or the like.

It will be appreciated that multiple factors or potential sources can be used in determining property possession, some of which may be external to the entity, and that it may be required to provide linguistic grammar to explicitly describe how the property possession may change as a function of the factor or factors being considered.

The possession of a property or the attribution of a property to an entity may be defined as a predicate, wherein the predicate may be mutual or unitary. For example, a car having a red color may be expressed as a predicate color(red, my_car). In an opposite example, ownership may be expressed as the owning(self, my_car) predicate, which is a mutual relationship. It will be appreciated that while the color property may be persistent, the ownership may be transient, since a car always has a color, but may have an owner only once it is sold.

In accordance with some embodiments, processing instructions may be provided which describe the dynamics of property acquiring and dismissal as a function of the various triggering factors, and specifically as a function of the target entity's lifecycle contexts.

Thus, an ontology of dynamic entities may implement for each transient property of an entity type a “possession formula” which may be based on value conditions of other properties of entity type which may include the specific entity type, or can be inferred from lifecycle traces of the entity or from external events. The possession formula may include the application of “property possession algebra”, i.e., a set of operations related to the acquisition and loss of properties. Thus each property may be associated with:

1. Property specification, which may include the property name and type, and may also apply for persistent properties.

2. Possession formula for the property, which may be used to evaluate property possession at runtime. Such a formula may be realized as a set of acquisition or loss statements, each comprising two components: a possession instruction, e.g., acquire or lose the corresponding property; and a lifecycle context, e.g., a lifecycle indicators or operations performed thereon, which form a condition to the execution of the possession instruction. For example, “lose ‘guardian’ when ‘person’ becomes 18 years old”, “acquire ‘guardian’ when ‘person’ declared as incompetent”, or the like. A property may be indicated by its value, for example the guardian's name may be assigned as the value of the property “Guardian: John Smith”. In other embodiments, the value may be indicated as a predicate Guardianship (person, Jon Smith).

One technical effect of the disclosed subject matter relates to the provisioning of a system that supports an ontology comprising entity types having transient properties. The entity type specifies how its entities may acquire or lose properties based on stages or events occurring in the lifecycle of the entity. This enables greater flexibility in expressing the content and behavior of the entity, not only as a function of time but additionally or alternatively as a function of the entity's lifecycle.

Another technical effect of the disclosed subject matter relates to the enhanced functionality of integrating data from different systems, such that the acquisition and integration of data from one system into another may depend on the lifecycle of entities in one or more of the systems.

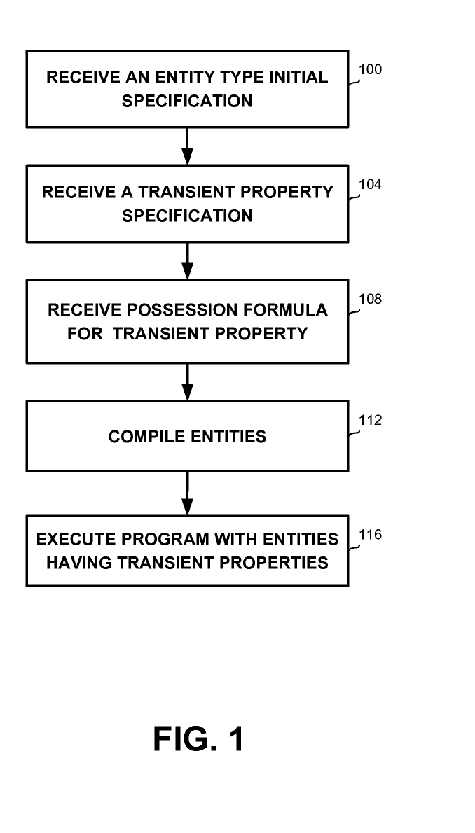

Referring now to FIG. 1, showing a flowchart of steps in a method for constructing an ontology having entities with transient properties.

On step 100, an initial specification of an entity type may be received, which may comprise a name or other characteristic, and may also comprise a lifecycle or a definition of one or more persistent properties, including for example the property name, type, default value, method implementation, or the like. It will be appreciated that any of such detail may be added, deleted or updated at a later time.

On step 104, a transient property specification of the entity type may be received. The specification of a transient property may have a type, a property name, default value, method implementation, or the like. It will be appreciated that any of such detail may be added, deleted, or updated at a later time. The transient property may be specified as a predicate, valued attribute, or the like.

On step 108 a possession formula may be received for the transient property, used for evaluating the property possession at runtime. The formula may be implemented as one or more statements, each comprising a possession instruction, i.e., acquire or lose the property, and a corresponding lifecycle context, i.e., conditions related to the lifecycle of the entity or associated entities.

It will be appreciated that steps 104 and 108 may be repeated for multiple properties, or step 104 may be performed multiple times followed by multiple executions of step 108, or any other combination.

On step 112, the definitions may be compiled or otherwise prepared for execution, depending on the specific environment, programming language, or the like.

On step 116, the executable program, module, library or any other component compiled on step 112 or otherwise created or received may be loaded into a memory device and executed to implement an environment for creating an ontology having entities with one or more transient properties.

It will be appreciated that when the program is loaded and executed, the status of an entity may be tracked during execution. When tracking the possession formula may be repeatedly evaluated, and in response to a change in the possession status the entity may be changed by adding or dropping the transient property.

Thus, the entity may intermittently comprise and not comprise the transient property during an execution of a computer program utilizing the entity. It will also be appreciated that a data model depicting the entity may be modified during execution of a computer program utilizing the entity, such that the data model may intermittently have and not have a data member depicting the transient property of the entity. A data model is a concrete specification of a data structure, e.g., nested, flat or the like, underlying a digital representation of the full manifest of properties possessed by an entity at any given point in time. For example, if properties are represented as valued attributes, the data model may also specify as a nested structure of valued attribute including for each attribute its name, data type (range of all possible assignments), default value, and the like.

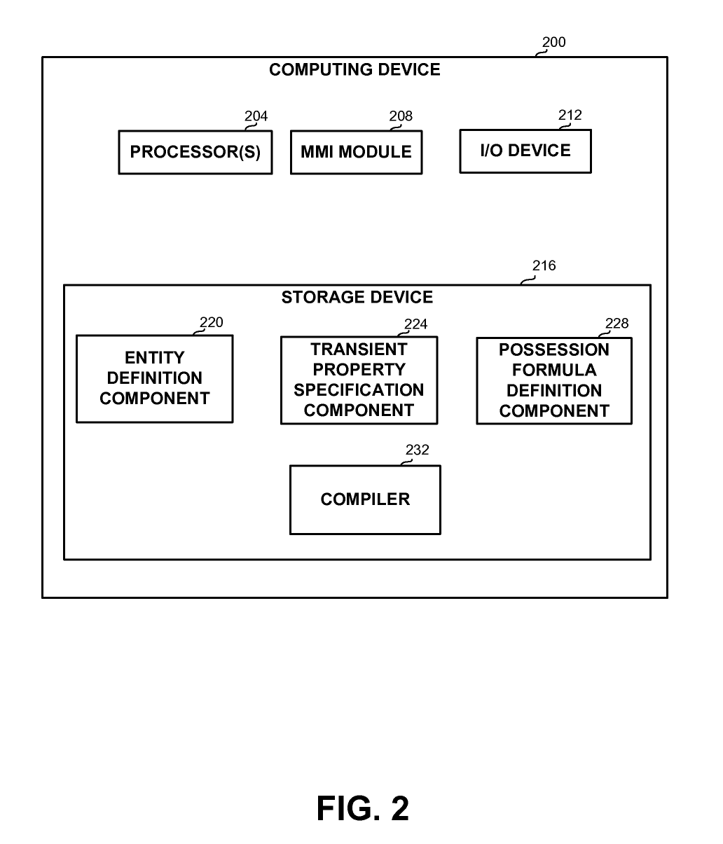

Referring now to FIG. 2, showing a block diagram of components of an apparatus for constructing an ontology having entities with transient properties.

The apparatus comprises a computing device 200, which may comprise one or more processors 204. Any of processors 204 may be a Central Processing Unit (CPU), a microprocessor, an electronic circuit, an Integrated Circuit (IC) or the like. Alternatively, computing device 200 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 204 may be utilized to perform computations required by computing device 200 or any of its subcomponents.

In some exemplary embodiments of the disclosed subject matter, computing platform 200 may comprise MMI module 208. MMI module 208 may be utilized to provide communication between the apparatus and a user for providing input such as describing the entities, the properties, and the possession formulae, providing output such as compilation results, or the like.

In some embodiments, computing device 200 may comprise an input-output (I/O) device 212 such as a terminal, a display, a keyboard, a microphone, a loudspeaker, or any other input or output device to interact with the system, to invoke the system and to receive results. It will however be appreciated that the system can operate without human operation and without I/O device 212.

Computing device 200 may comprise one or more storage devices 216 for storing executable components, and which may also contain data during execution of one or more components. Storage device 216 may be persistent or volatile. For example, storage device 216 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 216 may retain program code operative to cause any of processors 204 to perform acts associated with any of the steps shown in FIG. 1 above, for example receiving entity type specification, receiving property specification, receiving possession formulas, or the like.

The components detailed below may be implemented as one or more sets of interrelated computer instructions, loaded to storage device 216 and executed for example by any of processors 204 or by another processor. The components may be arranged as one or more executable files, dynamic libraries, static libraries, methods, functions, services, or the like, programmed in any programming language and under any computing environment.

Storage device 216 may comprise entity specification component 220, for letting a user edit or receive, and receiving an entity specification from a user, wherein the entity specification may comprise a name, persistent properties, or other characteristics.

Storage device 216 may also comprise transient property specification component 224, for letting a user edit or receive, and receiving an indication for of one or more transient properties, as described in association with step 104 of FIG. 1 above.

Yet another component of storage device 216 may be possession formula definition receiving component 228 for letting a user edit or receive, and receiving possession formula of one or more transient properties specified using transient property specification component 224. The possession formula may be associated with a condition or a stage in the lifecycle of the entity.

Storage device 216 may also comprise a compiler 232 for compiling or otherwise interpreting the defined entities, transient properties and their associated possessions formula.

It will be appreciated that entity definition component 220, transient property specification component 224 and possession formula definition component 228 may be implemented separately, together, or in any combination thereof, and may also be implemented as part of or by using MMI module 208.

### EXAMPLES

When the entity under discussion is a car, the property price(100$, car) may be associated with the following “possession formula” statements: {(acquire, on_completion_of manufacturing), (lose, on_total_loss)}, i.e., the price as a property of a car is determined as being possessed only after the car is fully manufactured. Similarly, in case of extreme damage, a car will no longer have a price. It will be appreciated that in this example, the possession of price as a property cannot be expressed as a function of time (e.g., ‘on_total_loss’ time is unknown at design time). Hence, it may be required to provide grammar that enables formulating the property possession as a function of various contextual factors, including factors that stem from inherent information (e.g., manufactured) about the possessing entities themselves.

In another example, the physical property of magnetic attraction between materials may be formulated as a transient property: attractedTo(matter1, matter2) for which the corresponding “possession formula” may be formulated as follows:

{(acquire,opposing(charge(matter1,v1),charge(matter2,v2)),(lose,opposing(charge(matter1,v1),charge(matter2,v2)))}

wherein v1 and v2 are the charges of the two materials, respectively, and the determination whether the property attractedTo is possessed, may be derived from the capability to determine the charges v1 and v2.

For convenience purposes, a tagging mechanism may be used at runtime for annotating each property with a possession indicator which may be modified each time an acquisition or a loss event is triggered. Using this annotation, instead of having to evaluate historical traces of property acquisition and loss, there will be an immediate indication for whether the property is possessed or not. Furthermore, lifecycle indicators may themselves be specified as properties. In the example above, on_completion_of manufacturing(true/false, car) and on_total_loss(true/false, car) may both be specified as persistent properties rather than as events.

Thus, the possession of an entity's property may be determined at runtime based on evaluation of the property possession formula. In some cases, for example in the guardianship example disclosed above, the possession of a property can be at least partially determined statically at design time. Given a set of “possession analysis” criteria, it may be determined that the expression specified by the possession formula depends upon properties of the entity that have known values at specific stages of the entity's lifecycle. In order to facilitate such static determination, the lifecycle may be modeled explicitly, specifying notions such as stages and milestones, and their relationships. Static analysis may be further simplified when the lifecycle does not contain cycles, i.e., the entity cannot go back from a later stage to an earlier stage.

The following example relates to implementing transient properties within the Semantics of Business Vocabulary and Business Rules (SBVR) standard as adopted by the Object Management Group (OMG) as part of the Model Driven Architecture (MDA) and intended to be the basis for formal and detailed natural language declarative description of a complex entity, such as a business. SBVR is intended to formalize complex compliance rules, such as operational rules for an enterprise, security policy, standard compliance, or regulatory compliance rules. Such formal vocabularies and rules can be interpreted and used by computer systems. The examples below use the SBVR “Structured English” grammar for convenience. It will, however, be appreciated that the underlying ideas are agnostic to the concrete grammar used to specify an entity's lifecycle model.

When a property is: 1. accessed at some point in the lifecycle of an entity; 2. the possession formula refers to either (a) persistent properties, or (b) transient properties that are in themselves possessed, and 3. the referenced properties have expected values, then it can be determined that the accessed property is possessed at that point in the lifecycle. A persistent property is always possessed at any point in the lifecycle.

Since properties may be mutable or immutable in addition to being persistent or transient, the mutability of a property is also indicated in the examples below. The examples below follow the practice of underscoring SBVR noun concepts, showing relationships (verb concepts or fact types) using italics, and capitalizing keywords such as “if”.

The example relates to a “car” having the following properties:
Persistent+immutable: Car has Passenger_Capacity/Passenger Capacity of Car
Persistent+mutable: Car has Colour/Colour of Car
Transient+immutable: Car has Offering_Price/Offering Price of Car
Transient+mutable: Car has Owner/Owner of Car

The example may further relate to a “Car Title” having the following properties:
Persistent+immutable: Car Title refers to Car/Car is referred to by Car Title
Transient+mutable: Car Title has Issue Date/Issue Date of Car Title

Integrity constraints, which are required to hold at all stages for all entities, may be defined for the persistent properties of “Car” and “Car title”:
EACH Car has EXACTLY ONE Passenger Capacity
EACH Car has AT LEAST ONE color
EACH Car Title refers to EXACTLY ONE Car

For each transient property, a possession formula may be defined in terms of the following assumed lifecycle stages.
For Car: Manufacturing→Selling→Utilizing→Selling
For Car Title: Pending→Issuing→Transferring→Pending

Milestones may be defined which are related to reaching any of the stages for the entities above. The milestones may be defined as special types of characteristic in SBVR. A characteristic is a unary verb concept having Boolean type. The “milestone” characteristic types for Car may be defines as:
Car has been manufactured
Car has been sold
Car is in use
   And the “milestone” characteristic types for Car Title may be defines as:
Car Title is pending
Car Title has been issued
Car Title has been transferred

For any transient property of an entity, a dis/possession formula may be defined which evaluates to a true or false Boolean result. The possession formula may use an SBVR “necessity” modality:
IT IS NECESSARY THAT EACH Car has EXACTLY ONE Offering_Price IF THE Car has been manufactured

A dispossession formula may use an SBVR “impossibility” statement:
IT IS IMPOSSIBLE THAT a Car has Offering_Price IF THE Car has NOT been manufactured

A combination possession formula for entity-property combination Car has Offering Price using “if and only if”, allows a shorthand notation for the conjunction of the two previous IF statements. In addition, “always” may be used as an alternative for expressing “necessity”:
A Car ALWAYS has EXACTLY ONE Offering Price IF AND ONLY IF THE Car has been manufactured

The following expressions exemplify combination formulae:
A combination possession formula for “car has owner” may be defined as:
   IT IS NECESSARY THAT EACH Car has AT LEAST ONE Owner IF AND ONLY IF THE Car has been manufactured AND THE Car has been sold
A combination possession formula for “car has car title” may be defined as:
   IT IS NECESSARY THAT EACH Car has EXACTLY ONE Car Title IF AND ONLY IF THE Car is in use
A combination possession formula for “car title refers to a car” may be defined as:
   IT IS NECESSARY THAT EACH Car title refers to EXACTLY ONE Car IF AND ONLY IF THE Car title has been issued
A combination possession formula for “car title has issue date” may be defined as:
   EACH Car title ALWAYS HAS EXACTLY ONE Issue Date IF AND ONLY IF THE Car title has been issued AND THE Car referred to by THE Car Title is in use.

In the above expressions related to Car Title, the conditions are partly defined in terms of another entity, being Car. The above formulae may be simplified if production rules are defined for a 2 milestone sequence, e.g., “Car has been sold” will also imply “Car has been manufactured”. Therefore, from the following formula:
IT IS NECESSARY THAT EACH Car has EXACTLY ONE Offering_Price IF AND ONLY IF THE Car has been manufactured
   It can automatically be inferred that:
IT IS NECESSARY THAT EACH Car has EXACTLY ONE Offering_Price IF THE Car has been sold

As defined above, the first portion. i.e., the manufacturing portion of the lifecycle of a car has no cycles, because a car cannot go back from “has been sold” to “has not been manufactured”. Thus it may be statically determined that the transient property called Offering Price is available once the “Car has been manufactured”.

It will be appreciated that computer instructions for enriching environments such as SBVR or others may be stored on non-transient computer readable media in order to provide a programming environment enabling the development of ontologies having entities with transient properties depending on stages and events in the lifecycle of the entity.

In some programming environments, an approach is sometimes used, referred to as “NULL pointer accepting”, in which a property which is inherently transient is implemented as a persistent property of type pointer which may be null when the property is not present. However, when such null pointer is received, there is no way of finding out why it is null, and how it is related to the state of the entity.

The disclosure may be used in any programming language or environments, for example database or ERP environments in which it may be required to integrate data from multiple systems, or to collaborate information from multiple sources, to obtain benefits associated with business integration and creation of corresponding shared vocabularies.

The disclosure may be used in a wide variety of application, such as health care, education, information management, communication systems

Instructions such as disclosed above may also be integrated into standards such as W3C OWL, OMG SBVR, or others and extend their semantics. Additionally or alternatively, an object oriented programming language or environment may be extended to support transient properties of object types.

It will be appreciated that the disclosure relates also to a data model which may be retained on a non-transitory computer readable medium, the data model associated with an entity manipulated by a computer program, wherein the data model comprises an entity definition of the entity, wherein the entity definition comprises a transient property of the entity, and wherein the entity definition comprises a possession formula for the transient property, the possession formula associated with a stage or condition in a lifecycle of the entity. The entity definition may comprise two or more different properties having two or more possession formulae, wherein when executed an entity based upon the entity definition may possess only the first property, only the second property, the first property and the second property, or none of the first property and the second property.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like, conventional procedural programming languages, such as the “C” programming language or similar programming languages, scripting languages such as Perl, Python, Ruby, or any other programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving an initial entity type specification, the initial specification comprising lifecycle of the entity type;
receiving an indication of a transient property for the entity type; and
receiving a possession formula for the transient property,
wherein the possession formula is associated with a stage or condition in the lifecycle of at least one entity type.

2. The computer-implemented method of claim 10, wherein the possession formula comprises at least one statement comprising: an acquire or lose indication, and a condition associated with the lifecycle of the entity type.

3. The computer-implemented method of claim 1, further comprising:
tracking status of the entity during execution of a computer program retaining the entity;
repeatedly evaluating the possession formula; and modifying the entity in response to evaluating the possession formula, wherein said modifying is selected from the group consisting of: dropping the transient property and adding the transient property to the entity.

4. The computer-implemented method of claim 1, wherein the entity intermittently having and not having the transient property available during an execution of a computer program utilizing the entity.

5. The computer-implemented method of claim 1, wherein a data model depicting the entity is modified during execution of a computer program utilizing the entity, wherein the data model intermittently having and not having a data member depicting the transient property of the entity.

6. The computer-implemented method of claim 1, wherein possession of a transient property is determined at design time.

7. The computer-implemented method of claim 1, wherein possession of a transient property is determined at run time.

8. The computer-implemented method of claim 1, wherein the possession formula is associated with a stage or condition in the lifecycle of at least one entity of the entity type, or of at least one entity of another entity type.

9. The computer-implemented method of claim 1, wherein the initial specification comprises at least one persistent property of the entity type.

10. An apparatus having a processing unit and a storage device, the apparatus comprising:
an entity receiving component for receiving an initial specification of an entity type, the specification comprising lifecycle of the entity type;
a transient property specification receiving component for receiving an indication specification of the entity type; and
a possession formula receiving component for receiving a possession formula for the transient property,
wherein the possession formula is associated with a stage or condition in the lifecycle of an entity type.

11. The apparatus of claim 10, further comprising a compiler for compiling the initial specification of the entity type, the transient property specification, and the possession formula.

12. The apparatus of claim 10, further comprising a Man Machine Interface (MMI) module for receiving input from a user.

13. The apparatus of claim 10, wherein the possession formula comprises at least one statement comprising: an acquire or lose indication, and a condition associated with the lifecycle of the entity type.

14. The apparatus of claim 10, wherein the possession formula is associated with a stage or condition in the lifecycle of at least one entity of the entity type, or of at least one entity of another entity type.

15. The apparatus of claim 10, wherein the initial specification comprises at least one persistent property of the entity type.

16. A data model retained on a non-transitory computer readable medium, the data model associated with an entity type, wherein entities of the entity type are manipulated in a computer program, wherein the data model comprising
entity specification of the entity type, wherein the entity specification comprises lifecycle and at least one property of the entity type, wherein the at least one property comprises a transient property of the entity type;
wherein the entity specification comprises a possession formula for the transient property, wherein the possession formula is associated with a stage or condition in the lifecycle of an entity type.

17. The data model of claim 16, wherein the entity specification comprises at least a first transient property and a second transient property having at least two different possession formulae, wherein when executed an entity based upon the entity definition may possess only the first property, only the second property, the first property and the second property, or none of the first property and the second property.

18. The data model of claim 16, wherein the possession formula is associated with a stage or condition in the lifecycle of at least one entity of the entity type, or of at least one entity of another entity type.

19. The data model of claim 16, wherein the possession formula is associated with a stage or condition in the lifecycle of at least one entity of the entity type, or of at least one entity of another entity type.

20. A computer program product stored on a non-transitory computer readable medium, the computer program product comprising:
a first program instruction for receiving an initial entity specification associated with an entity type, the initial entity specification comprising lifecycle of the entity type;
a second program instruction for receiving an indication of a transient property for the entity type; and
a third program instruction for receiving a possession formula for the transient property,
wherein the possession formula is associated with a stage or condition in a lifecycle of at least one entity, and
wherein said first and second program instructions are stored on said non-transitory computer readable medium.

21. The computer program product of claim 1020, wherein the possession formula comprises at least one statement comprising: an acquire or lose indication, and a condition associated with the lifecycle of at least one entity of the entity type, or of at least one entity of another entity type.
